(19) United States
(12) Patent Application Publication
(10) Pub. No.: US 2009/0016798 A1
(43) Pub. Date: Jan. 15, 2009

(54) Writing instrument with embedded decorative elements

(76) Inventor: Michael Dunn-Rankin, Venice, FL (US)

Correspondence Address: Michael Dunn-Rankin, 502 Warwick Dr., Venice, FL, 34293, US

(21) Appl. No.: 11/825,610

(22) Filed: Jul. 9, 2007

(51) Int. Cl. B43K 27/00

(52) U.S. Cl. 401/34

(57) ABSTRACT

A writing instrument is made of different colors. That difference includes the writing core as well is the outer sleeve. The writing core having different colors is produced by extrusion of the core. The extrusion can create different layers, different stripes or just blobs of different colors. The writing core could also present a logo by way of extrusion or molding. The writing core will produce different color stripes on paper. The outer sleeve surrounding the core can also be co-extruding and also in different colors. The outer sleeve would have to be somewhat harder than the core but both could be subjected to a pencil sharpener. The writing core could also be encased in wood or plastic whereby the casing in wood or plastic would have to be manufactured in two halves to encase the extruded writing core. The wood or plastic material could be surrounded by a sheet having colors thereon. The extruded outer sleeve could also contain a retractable ball point pen.

### FIELD OF THE INVENTION

The invention relates to writing instruments such as pencils and pens. Pens and pencils are frequently decorated with advertising or theme adornments and distributed widely as a way to communicate a message or theme.

### BACKGROUND OF THE INVENTION

The present invention pertains to writing instrument having decorative elements embedded within the pen or pencil at the time of manufacture such that these elements are visible at either end of the instrument. The present invention offers a more durable and novel method of embellishment wherein the decoration is formed from variations of color or texture in the material from which the instrument is made. The concept is similar to the method used to make candy canes wherein different colors of sugar candy are combined and intertwined prior to extrusion resulting in a piece of candy, greatly reduced in size from the original log or roll yet containing in miniature the design first assembled in the raw material stage Plastic extrusions are ubiquitous in the prior art and the extrusion process has become highly sophisticated and is well capable of forming pen and pencil bodies according to the present invention

### BRIEF DESCRIPTION OF THE INVENTION

An object of the invention is to provide a pen or pencil having decorative or theme elements embedded in the material forming the main body of the instrument.

It is a further object of the invention to provide a pen or pencil having a plurality of colors embedded within the body and to have such embedments visible from the proximal to the distal end of the instrument.

The present invention is a pen or pencil body which, during its manufacture is formed from materials having different colors or textures. These variegated materials while being combined to form the main body of the instrument, simultaneously produce a pattern which exhibit's a textural or purely decorative or symbolic message or theme. It is envisioned that it will create a new variation on the theme of decorated writing instruments and produce another, novel, medium for pen and pencil manufacturers to create for sale to consumers

The embedment process is limited only by the types of materials used. Obviously, each separate color must retain a close affinity for a neighboring color such that they can be combined without co-mingling and thereby the message or theme.

### BRIEF DESCRIPTION OF THE DRAWINGS

FIG. 1 is an isometric view of a layered pencil;

FIG. 2 is a further isometric view of a pencil having varies embedments therein;

FIG. 3 is a perspective view of a pencil having an embedded logo therein.

FIG. 4 is a view of FIG. 3 having a ball point pen located therein;

FIG. 5 shows a writing instrument having a logo therein;

FIG. 6 shows the illustration of FIG. 4 having clear plastic sleeve thereon;

FIG. 7 illustrates a wooden pencil having a multicolor writing core therein;

FIG. 8 illustrates a writing instrument of FIG. 7 with a different sleeve;

FIG. 9 shows a writing instrument made of different components;

FIG. 10 shows the instrument of FIG. 9 in an exploded view.

### DETAILED DESCRIPTION OF THE INVENTION

Referring now to the drawings in which like numerals designate like and corresponding parts throughout the several views

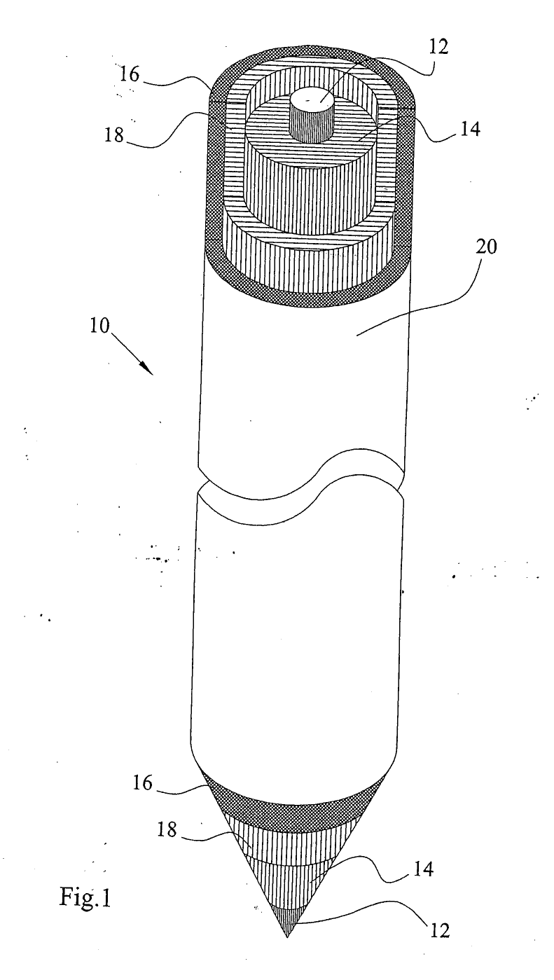

FIG. 1 illustrates a pencil designated with numeral 10. The main body of the pencil is shown at 20. The main body shows several layers 14, 16 and 18. The several layers have been obtained by co-extruding the same simultaneously The center lead core 12 is co-extruded at the same time by being fed into the center of extruding device. When the pencil has been extruded and a pencil sharpener produces the writing tip, the co-extruded layers, 14, 16 and 18 become visible as a decorative aspect.

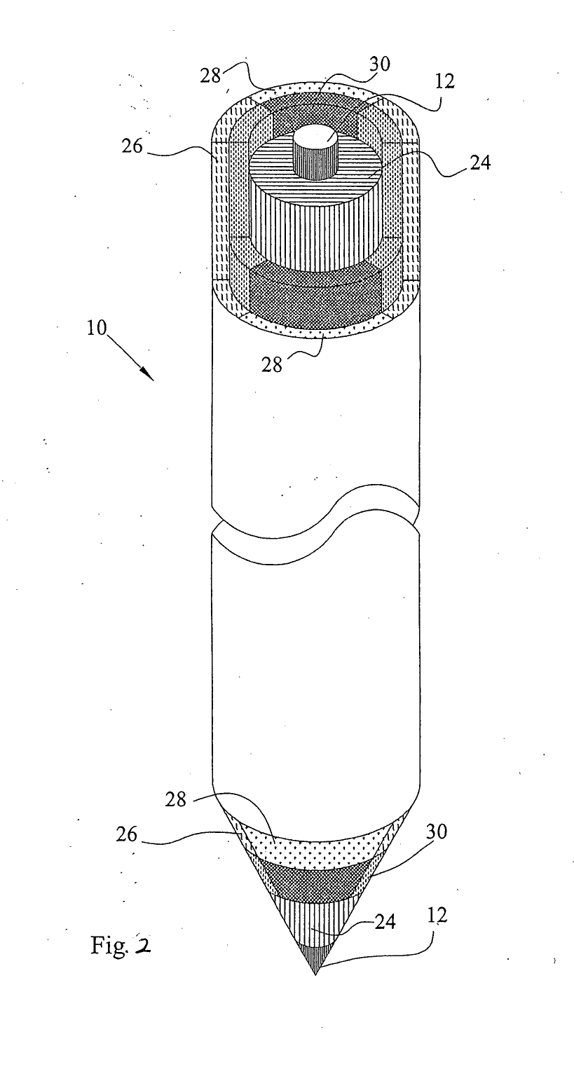

FIG. 2 Is the same concept as was shown in FIG. 1 but is showing a different configuration of layers 24, 26, 28 and 30. The layers are so arranged to create a different pattern by using a different extrusion arrangement. When the tip is sharpened, the pattern at the writing end of the pencil will appear.

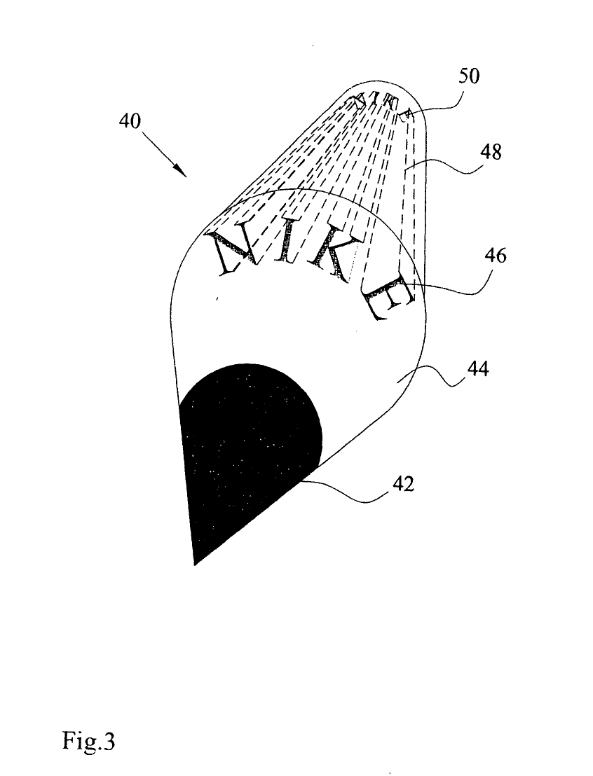

FIG. 3 illustrates a further embodiment wherein a trade mark name is embedded in the mantle or cover of the pencil. It is mere undertaking to so arrange the extrusion orifices in such a manner to produce the trade mark name shown in FIG. 3. The name will continue to appear as the pencil continues to be sharpened even if it gets shorter in the process. The extrusion process is not shown because it is such well known process in other areas of plastics. In this manner any trade mark could be reproduced. In FIG. 3 the pencil is indicated by the numeral 40. 42 indicates the lead as the writing media. The extrusion 48 is exposed and the trade name becomes visible upon sharpening. 46 is one of the extrusions of the trade name. The extrusions 48 of the text 50 are embedded in the main body.

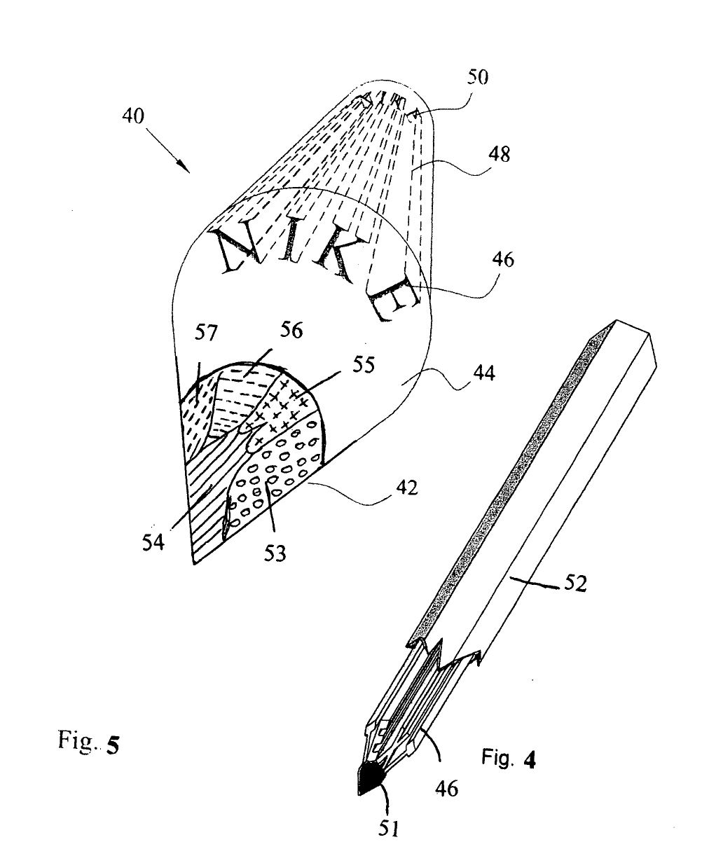

FIG. 4 is a perspective view of the writing instrument of FIG. 3, however, the writing core in this embodiment is a ball point pen embedded therein. The tip of the ball point is shown at 51. Another feature in this embodiment is that the outer sleeve 52 is made of a clear plastic in the form of a the outline of a pencil. This clear plastic sleeve may applied to other embodiments as well during the process of extrusion.

FIG. 5 is a perspective view of yet another embodiment. The basic principle of this embodiment is shown in FIG. 3, however, the writing core 41 in this embodiment is quite different because it is made of variegated color appearances. The appearance is marked by patches or spots of different colors. The different colors are mixed into the initial extrusion substance by way of blobs that will appear as unorganized colors 53-57 in the writing core and will appear as variegated color lines once applied to paper. A pencil sharper will create different color images.

In all of the embodiments disclosed above, the outer sleeve may be made of wood or plastic. After the writing core has been extruded, the core is covered with wood or plastic material. Since wood cannot be extruded, the wooden sleeve or mantle is made of two halves which are then combined into a unitary construction by gluing.

The outer sleeve can then be covered by a printed paper sleeve having all kinds of messages or colors thereon. The printed paper sleeve is first subjected to printing and then is rolled onto the wooden sleeve of the pencil and then glued thereon.

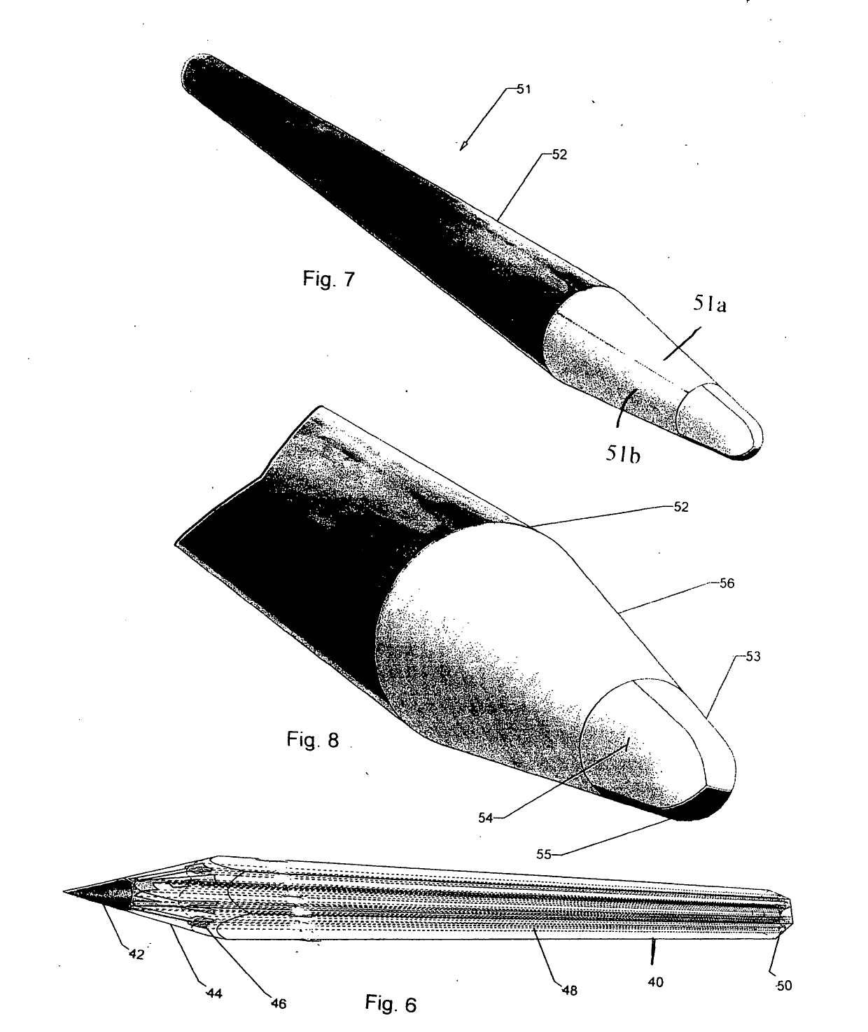

FIG. 6 shows still another embodiment 40 having a writing core 42 which is enclosed by having a logo or text 46 thereon which can or will be extruded and then during extrusion is covered with an entire clear plastic sleeve 48 there over.

FIG. 7 illustrates a writing instrument 51 having a writing therein that made up of different colors 53, 54, and 55 (FIG. 8), but in this case the different colors are kept parallel to each other during extrusion. This enables a user of this writing instrument to switch to different colors simply by turning the instrument while writing. The outer sleeve is manufactured by wood or plastic by combining two halves 51a and 51b with each other whereby the writing core (53, 54, 55) is embedded therein. The outer sleeve is covered by having a multi-colored paper sleeve glued thereon, as was explained above. The writing instrument can be sharpened through the use of a pencil sharpener.

FIG. 8 is similar in construction as was explained in FIG. 7 but the sleeve around the core can be extruded from a plastic material 56 and again be covered with a multi-color paper sleeve for decorating purposes. This writing instrument can also be sharpened by way of a pencil sharpener.

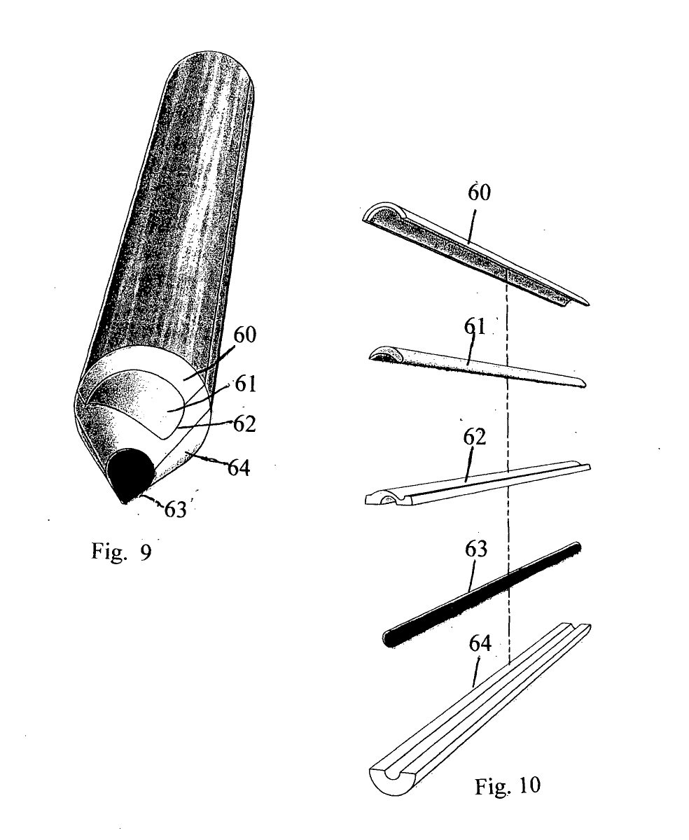

FIG. 9 shows another embodiment of a writing instrument which is constructed of different elements. There are two outer elements 60 and 64 which are made of wood. As mentioned above, wood pulp cannot be extruded because the pulp would have no cohesion during extrusion. However, wood pulp or plastic can be molded in a mold base, which is happening in this case. Then there is a form 61 in the form of a logo which could be extruded from a plastic material. The next component or element 62 is a profiled element that is so made to snugly accept the logo 61 thereon to form an upper curve which will snugly fit in the outer element 60. The under side of the profiled element 62 has a curve therein to accept a round writing core of graphite therein. Finally, the other outer element 64 is placed under the total assembly to complete a writing instrument.

The assembly just described in combination with FIG. 9 or 10 could also be accomplished by not using an extrusion of the logo 61 but by leaving a void of a logo when assembling the above described instrument and injecting the logo into the void in liquid form and to let the liquid harden in due time. This procedure allows a multiple of the same assemblies at the same time but to chose different colors for the logo at a later time after the various elements have been assembled.

It should also be noted the a relatively new technique may be used to construct the various elements of the various writing instruments disclosed above. The technology is known as rapid prototyping. Today, they are used for a wide range of applications and are even used to manufacture small production quality parts in relatively small numbers. This technology would lend itself well for the production of the various plastic elements required in the production of the inventive writings instruments.

Most of the elements of the disclosed writing instruments are made of plastic materials which lend themselves easily to molding, extruding or rapid prototyping. This does not include the formation of wood pulp which would have to molded.

What I claim is:

1. A writing instrument having an outer sleeve and a writing core made up of different colors, the writing core is soft enough to be used as a writing instrument and soft enough to be sharpened by a pencil sharpener, the writing core of different colors is formed during a process of extrusion.

2. The writing instrument of claim 1, wherein said different colors are made in different layers.

3. The writing instrument of claim 1, wherein said different colors are made in different stripes.

4. The writing instrument of claim 1, wherein said different colors are made by adding different color blobs to the extrusion substance.

5. The writing instrument of claim 1, wherein said writing core is made to exhibit a logo.

6. The writing instrument of claim 1, wherein said outer sleeve is co-extruded with said writing core but of a harder substance than the substance of the writing core.

7. The writing instrument of claim 6, wherein said outer sleeve is of different colors.

8. The writing instrument of claim 7, wherein said writing core is replaced by a ball point pen.

9. A writing instrument of claim 1, wherein said outer cover is made of wood.

10. The writing instrument of claim 9, wherein said outer cover made of wood is covered by a flexible sheet having multi-colors thereon.

11. A writing instrument made up of different elements, said elements comprising at least outer covers, a profiled element representing a logo is placed below one of said at least two outer covers, a double sided profiled element is placed below said profiled element, a writing core element is placed below said double sided profiled element and another of said at least two outer covers is placed is below said writing core element.

12. The writing instrument of claim 11 wherein said at least two outer covers are molded from a wood pulp.

13. The writing instrument of claim 11, wherein said profiled element representing a logo is being extruded.

14. The writing instrument of claim 1, wherein said at least two outer covers are extruded from a plastic material.

15. The writing instrument of claim 11, wherein said double sided profiled element is extruded.

16. The writing instrument of claim 11, wherein one side of said double sided profiled element is profiled to receive said logo element and wherein the other side of said doubled sided profiled element receives said writing core element.

17. The writing instrument of claim 11, wherein said writing core element is made of graphite

18. The writing instrument of claim 11, wherein said profiled element representing a logo can be installed in a liquid form after the writing instrument has been assembled.

19. The writing instrument of claim, wherein said writing core element represents multiple colors.

20. The writing instrument of claim 1 wherein said outer sleeve is manufactured by rapid prototyping.
